(19) United States
(12) Patent Application Publication
(10) Pub. No.: US 2016/0021830 A1
(43) Pub. Date: Jan. 28, 2016

(54) MANIPULATION OF LIGHT SPECTRAL QUALITY TO REDUCE PARASITISM BY CUSCUTA AND OTHER PLANT PARASITES

(71) Applicant: THE PENN STATE RESEARCH FOUNDATION, University Park, PA (US)

(72) Inventors: Beth Irwin Johnson, State College, PA (US); Mark Christopher Mescher, State College, PA (US); Consuelo Moreira De Moraes, State College, PA (US)

(21) Appl. No.: 14/571,850

(22) Filed: Dec. 16, 2014

Related U.S. Application Data
(60) Provisional application No. 61/916,924, filed on Dec. 17, 2013.

(51) Int. Cl. A01G 7/04; A01G 9/20; A01G 7/06; A01G 1/00; A01G 9/14

(52) U.S. Cl. CPC A01G 7/045; A01G 1/001; A01G 9/14; A01G 7/06; A01G 9/20

(57) ABSTRACT

The invention employs the use of light spectral manipulation as a defense method against parasitic plants in the genus Cuscuta. According to the invention, the manipulation of light spectra is employed to present a ratio of red light (650-670 nm) to far red light (710-740 nm) that is higher than natural sunlight. The manipulation can be passive, such as the use of photoselective film, or active, such as use of a lighting control mechanism within a plant cultivation house growth for delivering appropriate irradiation spectra to crops, such as the use of light-emitting diodes.

### CROSS-REFERENCE TO RELATED APPLICATIONS

This application claims priority under 35 U.S.C. §119 to provisional application Ser. No. 61/916,924 filed Dec. 17, 2013, herein incorporated by reference in its entirety.

### GRANT REFERENCE

This invention was made with government support under NSF CAREER No. 0643966 awarded by National Science Foundation. The government has certain rights in the invention.

### FIELD OF THE INVENTION

The invention relates to preventing infestation of plants by parasitic plants, which employs methods of light manipulation to disrupt host location or host attachment by the parasite.

### BACKGROUND OF THE INVENTION

Parasitic plants are plant species whose members acquire some or all of their nutritional resources by attaching to and extracting resources from other plants. As many as one percent of flowering plant species are parasitic, and some parasite species are among the most damaging pests of worldwide agriculture, causing reductions in crop quality and yield which affects global food security and commodity production.

Parasitic plants vary widely in their degree of dependence on the host. Some are photosynthetic and can survive without a host, but utilize available hosts to supplement their nutrition (facultative parasites, e.g., Triphysaria species). Others have an obligate requirement for a host, but still retain some photosynthetic capacity (obligate hemiparasites, e.g., Striga, Alectra, Cassytha, mistletoes and some Cuscuta species). Finally, some parasites have little or no photosynthetic capacity—indeed, some have lost much of their chloroplast genomes (DePamphilis and Palmer 1990; DePamphilis et al. 1997)—and depend entirely on host plants for nutrition (obligate holoparasites, e.g., Orobanche species and some Cuscuta species).

Parasites in the genus Cuscuta (principally C. campestris, but including several other species such as C. approximata, C. californica, C. epithymum, C. europaea, C. gronovii, C. indecora, C. japonica, C. pentagona, C. planiflora, C. reflexa, C. salina and C. suaveolens) attach to above-ground plant parts and are important weeds in Europe, the Middle East, Africa, North America and South America (Parker and Riches, 1993; Lanini and Kogan 2005). Cuscuta species, commonly referred to as “dodder,” attack and damage a wide variety of crops, including but not limited to forage crops such as alfalfa and red clover; fruits and vegetables such as asparagus, carrot, chickpea, citrus, cucumber, cranberry, eggplant, faba bean, garlic, grapevine, melon, lespedeza, onion, pepper, potato, sugarbeet, sweet potato, and tomato; some tree crops such as coffee; and ornamentals such as coleus, dahlia, geranium, impatiens and mint (Gaertner 1950; Dawson et al. 1994; Lanini 2004; Lanini and Kogan 2005; Costea and Tardif 2006; Albert et al. 2008).

There are over 200 described species in the genus Cuscuta (Costea 2007) and their common names—including tangle gut, strangle vine, devil's gut, and witches shoelaces—reflect their parasitic nature and pest status (Costea and Tardif 2006). Cuscuta species are difficult to control because of their wide geographical range and ability to utilize many different hosts, and there is currently a lack of effective yet practical control methods (Parker and Riches 1993; Sandler 2010). The intimate vascular connection between parasitic plants and their hosts severely limits the efficacy of non-selective herbicides against these pests because of non-target effects on host plants (Dawson et al. 1994; Albert et al. 2008). Furthermore, seed production by dodder species is prolific (with several thousand seeds produced by a single plant) and the seeds are capable of remaining dormant in the soil for decades (Gaertner 1950), creating a resilient seed bank with the potential to produce new infestations every year (Dawson et al. 1994). Several practices help reduce dodder infestations, including hand removal (Dawson et al. 1994; Costea and Tardif 2006), crop rotation (Dawson et al. 1994), mowing or burning infested fields (Cudney et al. 1992) and the use of resistant crop varieties (Goldwasser et al. 2001; Rispail et al. 2007; Goldwasser et al. 2012); however, no single control method consistently eradicates dodder. Control efforts work best when multiple methods are used together (Lanini and Kogan 2005), but there remains a need for improved control methods against this economically destructive pest (Sandler 2010).

Despite the economic and ecological significance of parasitic plants, relatively little is known about how parasitic plants locate and attach to suitable hosts and how environmental influences may alter these behaviors. Improved understanding of parasitic plant foraging and how environmental factors may influence—and potentially disrupt—host location or host acquisition may facilitate the development of new control methods for these destructive pests.

It is an object of the present invention to provide a novel method for reducing parasitism by Cuscuta species, and other parasitic plants that are functionally and biologically similar to dodders, namely Cassytha species.

Other objects will become apparent from the description of the invention, which follows.

### SUMMARY OF THE INVENTION

The invention uses light spectral manipulation as a novel defense method against parasites in the genus Cuscuta (including the following species: C. approximata, C. californica, C. campestris, C. epithymum, C. europaea, C. gronovii, C. indecora, C. japonica, C. pentagona, C. planiflora, C. reflexa, C. salina and C. suaveolens), as well as other parasitic plants that are functionally and biologically similar to dodders, such as Cassytha species. The process may be combined with existing prevention and maintenance methods in an integrated approach to prevent and reduce parasite infestations, providing growers with a completely new type of defense against dodder seedlings.

According to the invention, the manipulation of light spectra is employed to present a ratio of red light (650-670 nm) to far red light (710-740 nm) of about 0.7 to about 2.0 (termed high R:FR ratio). The manipulation can be passive, such as the use of photoselective film to filter sunlight such as through row covers, low tunnels, high tunnels or plastics used for soil treatments including plastic mulch. Moreover, the use of small photoselective canopies could treat localized field infestations or areas that are difficult to access such as cranberry bogs. The manipulation can also be active, such as employing a crop cultivation housing which includes a lighting control mechanism for delivering appropriate irradiation spectra to crops, such as the use of light-emitting diodes.

The light manipulation method can be used at any time during susceptible host plant development when a suspected dodder infiltration is detected or possible. This can include, for example, a pretreatment of a field prior to susceptible host crop planting to prevent parasitism, as well as during and after susceptible host crop planting. The light manipulation is preferably employed before dodder seed germination through early dodder seedling development. Light manipulation can be employed for a period of up to 6 weeks at a given application until one is satisfied that the dodder threat is removed.

According to the invention, dodder foraging and parasitism was significantly reduced in a high R:FR environment compared to control R:FR (the ratio of sunlight, about 0.659) or low R:FR (ratio of about 0.391) conditions. This effect was achieved using both passive and active methods of light manipulation, indicating that it is indeed the ratio of R:FR that affects host acquisition. Furthermore, this result was observed in two dodder species and as such the methods are anticipated to have a similar effect on other species including but not limited to other dodder species and other parasitic plants that are functionally and biologically similar to dodders (e.g., Cassytha species).

The preventative manner of this method is beneficial because it enhances control at two separate and sequential stages in the dodder life-cycle—host location and host acquisition—making this a unique and desirable approach in addition to traditional methods. Host location occurs when the parasite grows towards a host and continues until physical contact with the host, while host acquisition is characterized by a series of steps that are triggered once the parasite contacts the host. These steps entail the development of a physiological linkage between the parasite and host that allows resource extraction. In Cuscuta species, these steps typically include loose twining around host tissues followed by tight coiling around the host, prehaustoria formation, and mature haustoria formation (see Table 2 for definitions of each stage in the progression of parasitism). It is important to note that dodder seedlings that do not reach the prehaustoria or mature haustoria stages of parasitism are unable to form connections with host vasculature and consequently will die. The light manipulation method (high R:FR environment) reduced the number of dodder seedlings that successfully located and acquired a host plant, which reduced the number of successful infestations. Thus, this method would be useful for initially reducing the overall number of dodder seedlings that parasitize crop hosts, and existing control methods such as hand removal could be used secondarily to eliminate any remaining infestations.

The light manipulation method provides a non-invasive, chemical-free alternative to herbicide use that is especially ideal for organic production. It is also relatively inexpensive to employ compared to other costs incurred from controlling established infestations (e.g., purchasing genetically-engineered resistant crop varieties and corresponding selective herbicides, labor costs to remove established infestations by hand, profit losses from reduced crop quality and yield). Light spectral manipulation also has the potential to be deployed in ways that are more ecologically sustainable compared to traditional control methods. For example, photoselective film can be used in consecutive growing seasons to reduce waste and is made from materials that can be recycled after deterioration. Additionally, many of the new lighting technologies such as high power LEDs are extremely energy-efficient compared to other horticulture lighting options (e.g., high pressure sodium and metal halide lights).

As used herein, the term “plant” or “crop” or “host” can include reference to whole plants, plant parts or organs (e.g., leaves, stems, roots, etc.), plant cells, seeds and progeny of same. The class of plants which can be used in the methods of the invention is generally as broad as the class of higher plants susceptible to parasitism by Cuscuta spp. as well as other parasitic plants that are functionally and biologically similar to dodders (e.g., Cassytha species), including both monocotyledonous and dicotyledonous plants. This includes but is not limited to forage crops such as alfalfa and red clover; fruits and vegetables such as asparagus, carrot, chickpea, citrus, cucumber, cranberry, eggplant, faba bean, garlic, grapevine, melon, lespedeza, onion, pepper, potato, sugarbeet, sweet potato, and tomato; some tree crops such as coffee; and ornamentals such as coleus, dahlia, geranium, impatiens and mint.

### DESCRIPTION OF THE FIGURES

FIGS. 1A-1F show photographs of dodder parasitism progression categories: No Host Contact (a), Unsuccessful Attachment (b-d), and Successful Attachment (e, f). Detailed descriptions of each stage of parasitism progression: (a) No Host Contact—does not touch any part of the host (including trichomes); (b) Contact—comes in contact with the host but does not entwine more than 360°; (c) Loose Twine—entwines more than 360° but not in a tight coiling fashion; (d) Close Coil—entwines more than 360° as a tight coil (usually to the stem or petiole); no swellings present indicating haustoria formation; (e) Prehaustoria—coils tightly and small swellings are observed at the interface between parasite and host tissue; (f) Haustoria—fully connected to host xylem and phloem; haustorial swellings are prominent and a new parasitic shoot possessing an apical bud-like scale emerges from the site of attachment.

FIG. 2 is a photograph showing C. gronovii parasitizing jewelweed hosts after exposure to high R:FR (left tray), low R:FR (center) and control R:FR (right tray). Plants grew beneath the photoselective film treatments for 10 days and then the treatments were removed and plants continued to grow in full sunlight for an additional 15 days. Note the striking differences in parasite infestation and host plant size among the R:FR treatments.

FIG. 3 is a graph showing light conditions (photosynthetic photon flux density; i.e., the amount of light energy per unit wavelength) in the growth chamber used to germinate tomato seeds.

FIG. 4 is a graph showing light conditions (photosynthetic photon flux density) of sunlight compared to the control R:FR, low R:FR and high R:FR photoselective film treatments.

FIG. 5 is a schematic of the LED array (ELVIS) used for the Active Light Manipulation experiments.

FIG. 6 is a graph showing light conditions (photo synthetic photon flux density) of ELVIS for the control R:FR, low R:FR and high R:FR treatments.

FIGS. 7A-7D are graphs showing the short-term effects of R:FR treatment on (a) C. campestris seedling length, (b) the number of expanded tomato leaves, (c) tomato height and (d) tomato dry mass (mean±SE).

FIGS. 8A-8D are graphs showing the effect of R:FR on constitutive levels of host phytohormones (mean±SE): (a) total JA; (b) cis-JA; (c) trans-JA; and (d) SA. FW, fresh weight.

FIGS. 9A-9G are graphs showing the long-term effects of R:FR treatment on (a) the number of unopened flower buds, (b) the number of open flowers, (c) the number of senesced flowers, (d) the number of fruits, (e) fruit fresh mass, (f) fruit dry mass and (g) aboveground total plant dry mass (mean±SE).

FIGS. 10A-10D are graphs showing the constitutive levels of (a) total volatiles, (b) (+)-4-carene, (c) β-phellandrene and (d) β-caryophyllene after exposing tomatoes to each photoselective film R:FR treatment (mean±SE).

FIG. 11 is a graph showing the effect of R:FR on C. campestris period of circumnutation (mean±SE).

### DETAILED DESCRIPTION OF THE INVENTION

The effects of abiotic factors on host location and parasitism by parasitic plants are not well understood despite their economic importance as agricultural pests. Applicants have discovered a methodology to use light spectral manipulation as a novel defense method against Cuscuta species as well as other parasitic plants that are functionally and biologically similar to dodders (e.g., Cassytha species). The process may be combined with existing prevention and maintenance methods in an integrated approach to reduce the success of parasitism, providing growers with a completely new type of defense against dodder seedlings.

According to the invention the manipulation of light spectra is employed to present a ratio of red light (650-670 nm) to far red light (710-740 nm) of about 0.7 to about 2.0 (termed high R:FR ratio). The manipulation can be passive, such as the use of photoselective film to filter sunlight such as through row covers, low tunnels, high tunnels or plastics used for soil treatments including plastic mulch. Moreover, the use of small photoselective canopies could treat localized field infestations or areas that are difficult to access such as cranberry bogs. The manipulation can also be active, such as employing a crop cultivation housing which includes a lighting control mechanism for delivering appropriate irradiation spectra to crops, such as the use of light-emitting diodes.

The light manipulation method can be used at any time during susceptible host plant development when a suspected dodder infiltration is detected or possible. This can include, for example, a pretreatment of a field prior to susceptible host crop planting to prevent parasitism, as well as during and after susceptible host crop planting. The light manipulation is preferably employed before dodder seed germination through early dodder seedling development. Light manipulation can be employed for a period of up to 6 weeks at a given application until one is satisfied that the dodder threat is removed.

### Passive Light Manipulation Method

Sunlight filtered through different photoselective films created control R:FR, low R:FR and high R:FR environments for dodder seedlings to forage beneath. Foraging assays showed dodder seedlings were able to locate hosts (as indicated by growing significantly more often than expected by chance into the arena half and quadrant closest to the host plant within the foraging arena) in control R:FR and low R:FR environments while they were unable to locate hosts in a high R:FR environment. Attachment assays showed dodder seedlings had high rates of parasitism success (as indicated by the presence of prehaustoria and mature haustoria on hosts) in control R:FR and low R:FR environments while they were significantly less able to parasitize hosts in high R:FR environments. Thus, the high R:FR environment significantly reduced the location and parasitism of hosts by foraging dodder seedlings.

R:FR environment also affected several short- and long-term plant growth traits. Short-term effects (after only just 7 days of growth beneath the photoselective films): Tomato height was affected by R:FR environment; tomatoes were tallest when grown in low R:FR, intermediate in height in control R:FR and shortest in high R:FR environments. Also, tomatoes grown in control R:FR had significantly more dry mass than tomatoes grown in the low R:FR or high R:FR environments. The R:FR environment did not affect C. campestris seedling length, the number of fully expanded tomato leaves or constitutive levels of host plant phytohormones (jasmonic acid and salicylic acid). Long-term effects (grown beneath photoselective film for 7 days, then transplanted to full sunlight and harvested 54 days later): Tomatoes that were initially grown under high R:FR had significantly more unopened flower buds at the time of harvest compared to tomatoes initially grown under control R:FR or low R:FR treatments. Other traits were not influenced by the initial growth under different R:FR environments followed by extended growth in full sunlight (i.e., the number of open flowers, number of senesced flowers, number of fruits, fruit fresh mass, fruit dry mass and aboveground total plant dry mass).

### Active Light Manipulation Method

An array of adjustable light-emitting diodes (LEDs) created control R:FR, low R:FR and high R:FR environments under which dodder seedlings foraged.

In an active light manipulation method a lighting environment control facility is employed with lighting control means or crop cultivation house, using artificial light to adjust the state of the light to be irradiated on the crops that are cultivated inside the crop cultivation house.

For example, when the external light to be irradiated on the crop cultivation house is only sunlight, a quantity of light required to adjust the state of the light to be irradiated on the crops may not be obtained, for instance, when the weather is cloudy.

Even in this case, if a light source irradiating artificial light from the outside of the crop cultivation house is installed, the light to be irradiated from the light source can compensate for the quantity of light that is insufficient for such adjustment.

Then, it is possible to obtain a sufficient quantity of transmitted light, which is necessary to adjust the light to be irradiated on the crops in the crop cultivation house, regardless of the weather.

Means including a light source for irradiating light on the crop cultivation house, and control means for controlling operation of the light source may be adopted as means of irradiating the artificial light.

The light source includes the spectral radiance of the wavelength range of the red light, and the spectral radiance of the wavelength range of the far-red light in the emitted light. The control means is constructed to be made up of a house irradiation wavelength measuring apparatus, a crop irradiation wavelength measuring apparatus, and a controller optionally equipped with recording means.

The controller controls the light of the light source from signals sent from the house irradiation wavelength measuring apparatus and the crop irradiation wavelength measuring apparatus, which are relevant to wavelengths measured by these apparatuses, and from data of the recording means to adjust the state of the light to be irradiated on the crops to the optimum state for the growth of the crops at all times.

With the construction as mentioned above, the control means can adjust the light of the light source which is irradiated on the crop cultivation house so that a value high R:FR (higher than sunlight) environment is achieved.

The light source is preferably an instrument employing an LED that has a low calorific value as well as low consumption energy, but it is not limited to such an instrument. For example, the light source may be an instrument employing a fluorescent lamp, a discharge lamp using arc discharge or glow discharge, or the like. Further, the crop irradiation wavelength measuring apparatus and the house irradiation wavelength measuring apparatus are not particularly limited if they can output the measured wavelengths to an instrument capable of calculating R and FR on the basis of the intensities of the wavelengths. For example, a photometer for measuring emitted light may be used.

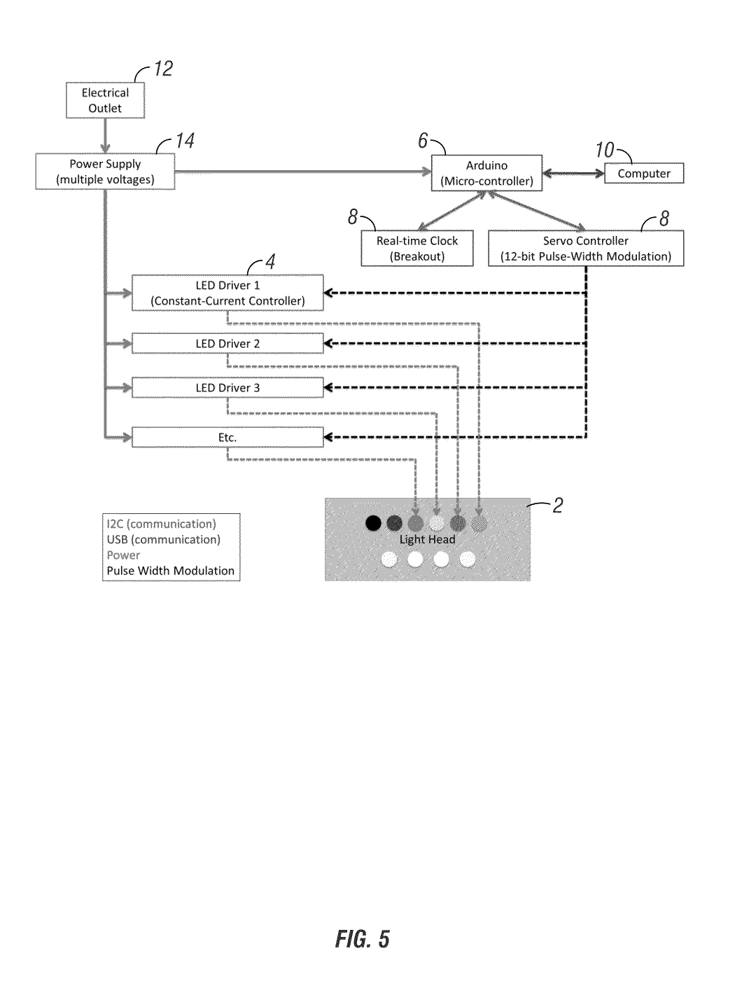

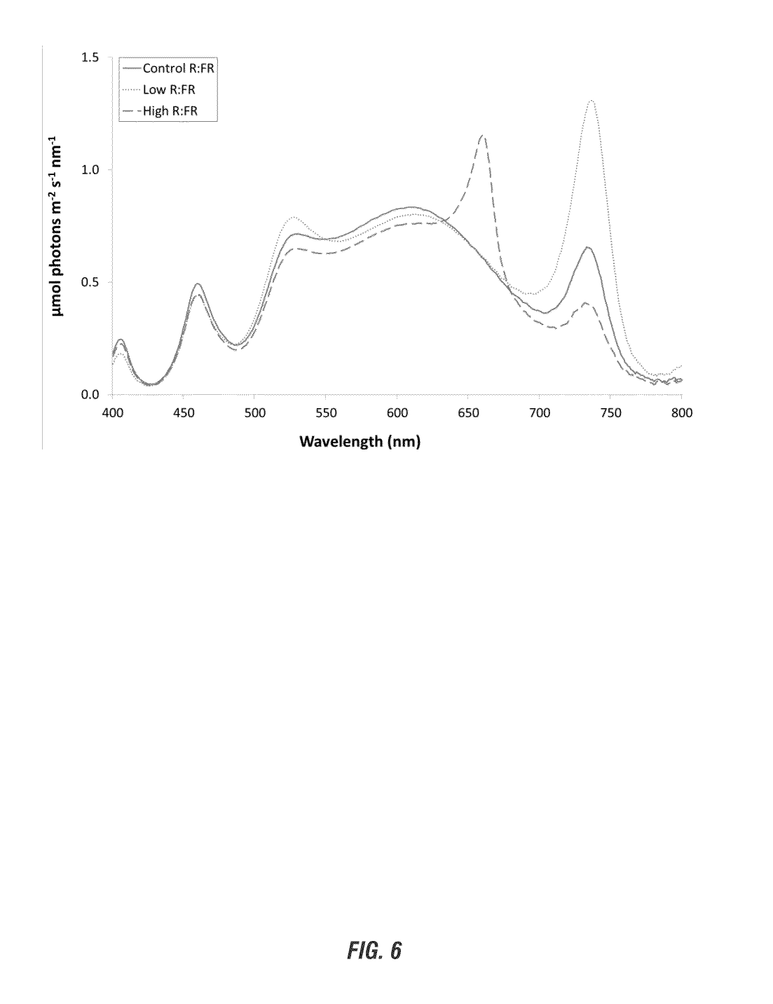

One embodiment for actively manipulating light is shown in FIG. 5. To actively manipulate light spectral quality and intensity, we used a computer, 10, controlled lighting system charged by an electrical outlet, 12, and a power supply, 14, which powered a custom LED light array called ELVIS (Effulgent LED Variable Intensity Spectrum). ELVIS comprised emitters with different spectra, 2, (UV, green, red, deep red, far-red, infra-red, neutral white and warm white) [LED Engin Inc., San Jose, Calif.] driven with a constant current controller, 4 [TheLEDArt.com, Akimitsu Sadoi, New York City, N.Y.] (FIG. 5). The intensity of each channel was regulated using an open source microcontroller, 6 [Arduino, Italy] and pulse-width modulated breakout board, 8 [ADA Fruit, New York City, N.Y.]. The ratio of R:FR of each ELVIS treatment was similar to the ratio of R:FR of the photoselective films, while the light intensity (the amount of photosynthetically active radiation) was similar across all ELVIS R:FR treatments (Table 1 and FIG. 6).

### Applicable Ratios of Red to Far Red Light

Attachment assays showed dodder seedlings were able to parasitize tomato hosts in control R:FR and low R:FR environments but were significantly less able to parasitize hosts in high R:FR environments. The rate of circumnutation of dodder seedlings was significantly faster in high R:FR environments compared to control R:FR or low R:FR environments.

Applicants have definitively shown herein that it is the ratio of radiation within the red and far-red wavelength regions—namely, a ratio of red to far-red light that is higher than the R:FR ratio of natural sunlight—that influences host location and parasitism success by dodders. Additionally, applicants have shown that it is the timing of deploying the light spectral manipulation method—namely, deploying the method during dodder seed germination stage throughout dodder seedling development—that directly inhibits host location and host acquisition of dodder seedlings.

Two methods were used to manipulate the ratio of red to far-red wavelengths: passive (filtering sunlight) and active (illumination with LEDs). Both methods showed dodder host acquisition was significantly reduced in high R:FR environments compared to control R:FR and low R:FR environments. Moreover, high R:FR affected two separate and sequential stages in the parasitism process: host location (foraging) and host acquisition (haustoria formation).

The sensitivity of dodder seedlings to two distinct cues—the ratio of red to far-red light and host plant volatile odors (Runyon et al. 2006)—confers an adaptive advantage by enhancing host location during the most vulnerable life stage of these obligate parasites: after seed germination and before the haustoria have made a secure connection to host xylem and phloem. Surprisingly, Applicants found high R:FR had a catastrophic effect on dodder host location and host acquisition. This new knowledge creates a unique opportunity to apply this information in novel ways for dodder management at specific time points during the dodder life cycle. The results show high R:FR reduces parasitism in two dodder species: C. gronovii, which is a major pest of cranberry and blueberry in the Northeast and northern Midwest USA as well as alfalfa, citrus, clover and grapevine (Dawson et al. 1994; Costea and Tardif 2006); and C. campestris, which is an extremely destructive international pest of dozens of crops (e.g., alfalfa, asparagus, beet, carrot, chickpea, clover, eggplant, faba bean, grape, melon, onion, potato and tomato as well as ornamental plants) (Costea and Tardif 2006). Thus, it is likely that high R:FR will disrupt the host acquisition process in other economically important dodder species (e.g., C. approximata, C. californica, C. epithymum, C. europaea, C. indecora, C. japonica, C. pentagona, C. planiflora, C. reflexa, C. salina and C. suaveolens; Lanini and Kogan 2005) or other parasitic plants that are functionally and biologically similar to dodders (e.g., Cassytha species).

A new form of dodder control for agricultural settings could employ both passive and active methods of light manipulation to prevent and reduce infestations, which would greatly improve upon the limitations of existing control methods. Currently, methods used to prevent dodder infestations include planting crop seeds that have not been contaminated with Cuscuta spp. seeds, crop rotation with non-hosts (i.e., some monocotyledonous plants such as corn), delaying planting of crops (e.g., frequently used for late-season crops like sugarbeet), using pre-emergent herbicides or planting dodder-resistant crop varieties and large transplants of crops (e.g., tomato) (Lanini and Kogan 2005). However, if a dodder infestation occurs there are several practices that can help reduce the impact. Selective herbicides may be used to destroy dodders attacking herbicide-resistant crops, but in some cases this is only a partial control solution (Lanini and Kogan 2005). Eliminating established dodder infestations is important in order to completely destroy the parasite before it produces seed. This can be done by tedious hand removal of the parasitic vines and all haustorial connections (otherwise they can regrow) or by mowing or burning the infested area. Yield loss occurs with these methods, but the loss helps prevent future infestations. In most cases it takes several years using a combination of practices to manage dodder effectively (Lanini and Kogan 2005).

The light spectral manipulation technique can be combined with existing prevention and maintenance methods in an integrated approach, providing growers with a completely new type of defense method against dodder seedlings. The preventative manner of this method is beneficial because it will enhance control at two separate and sequential stages in the dodder life-cycle—foraging and host acquisition—making this a unique and desirable approach for growers in addition to traditional forms of dodder control.

### Examples

### Manipulation of Light Spectral Quality Disrupts Host Location and Attachment by Parasitic Plants in the Genus Cuscuta

Applicants conducted assays with two dodder species and appropriate hosts: Cuscuta gronovii with jewelweed (Balsaminaceae: Impatiens capensis) and Cuscuta campestris with tomato (Solanaceae: Solanum lycopersicum var. Halley 3155). C. gronovii seeds were collected by J. D. Smith in 2010 from dodder-infested jewelweed (Centre County, PA) and kept refrigerated until use. To induce germination, seeds were scarified in concentrated sulfuric acid for 1 h in a porcelain Gooch crucible [CoorsTek Inc., Golden, Colo.], rinsed in distilled water for 1 min, rubbed on a paper towel to remove the acid-softened layer and placed in a Petri dish on moist filter paper to germinate. Naturally occurring jewelweed seedlings (i.e., host plants) were collected in April 2013 (University Park, Pa.), transplanted to greenhouse trays (52.4 cm×25.4 cm×5.4 cm) containing a peat-based general-purpose potting soil with 5 g of Osmocote® fertilizer (NPK: 14-14-14) [The Scotts Company, Marysville, Ohio] and grown outdoors until they were used for parasitism assays.

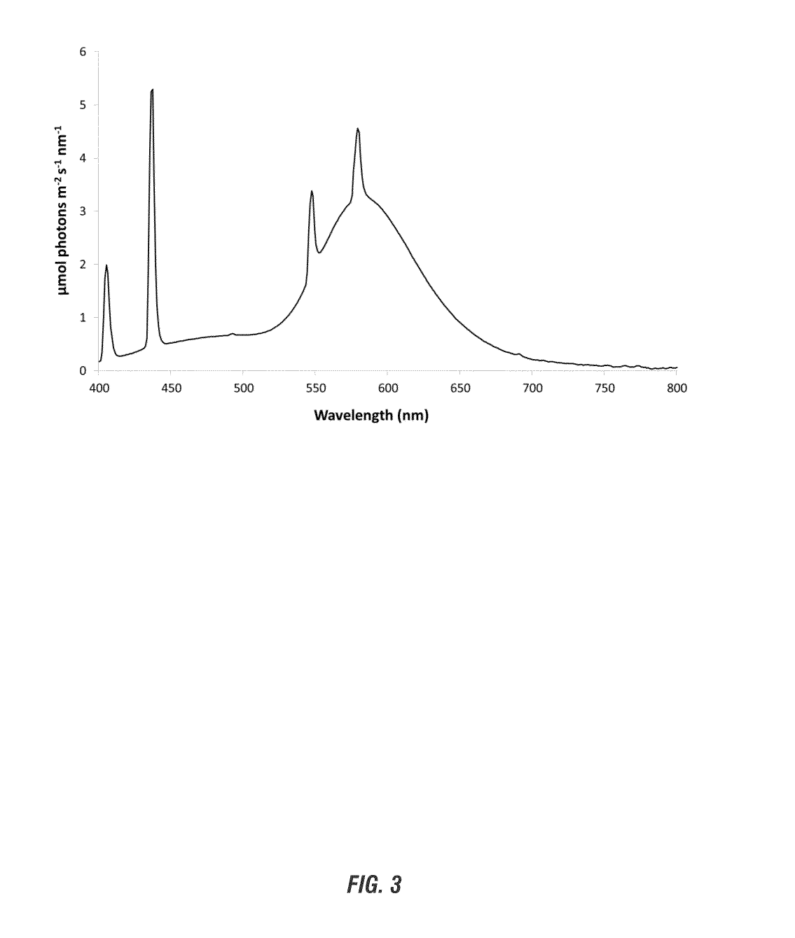

Cuscuta campestris seeds were collected by W. T. Lanini in 2010 from infested tomato fields (Yolo County, CA) and kept refrigerated until use. Germination was induced as above. Seeds of tomato hosts were planted in general-purpose potting soil (without fertilizer) and grown in an insect-free growth chamber (23° C., 16 hour photoperiod at 425 μmol m⁻² s⁻¹ provided by 215-W cool white fluorescent tubes; FIG. 3) until they were used for foraging and parasitism assays.

### Passive Light Manipulation

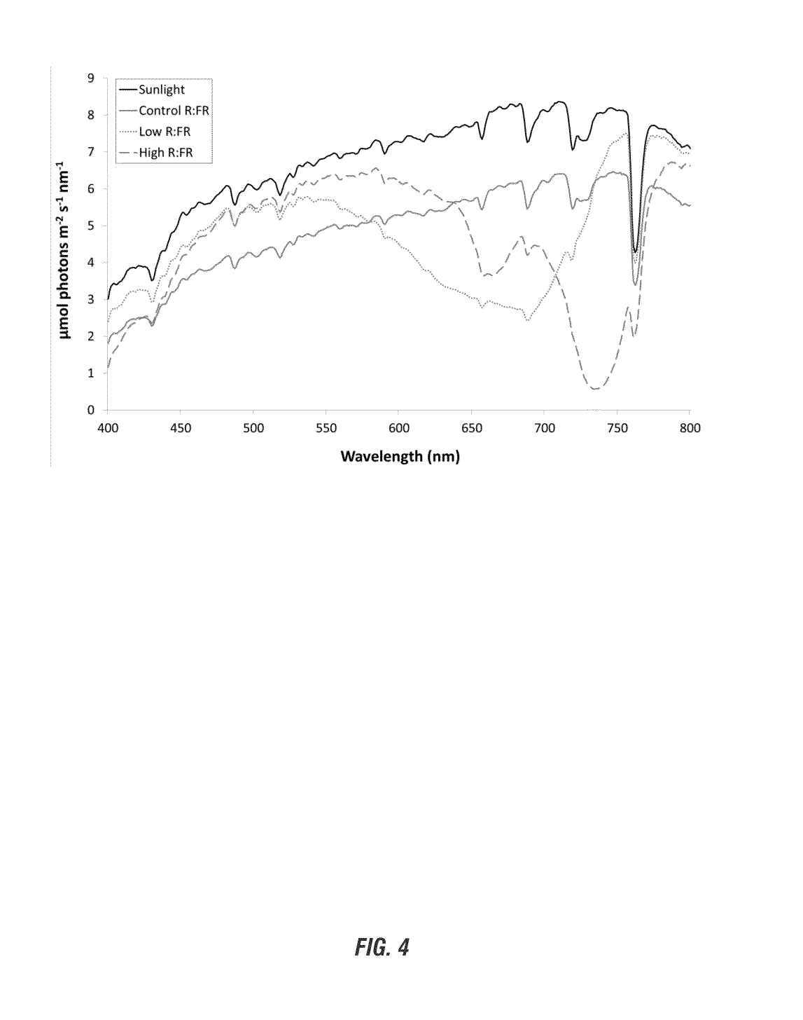

Three types of photo selective film were employed to manipulate R:FR ratios and the intensity of sunlight. A low R:FR treatment was created by filtering sunlight through Roscolux #4330 Calcolor 30 Cyan polyethylene terephthalate film [Rosco Laboratories, Stamford, Conn.] and a high R:FR treatment was created by filtering sunlight through Solatrol polyethylene film [BPI Visqueen Horticultural Products, Ayrshire, Scotland]. A non-selective film, E-Colour+ #130 Clear [Rosco Laboratories, Stamford, Conn.], was combined with Agribon+ AG-19 row cover shade cloth [Johnny's Selected Seeds, Waterville, Me.] to create a control treatment, with a R:FR ratio similar to that of sunlight, but with reduced light transmission approximating the reduction in light intensity imposed by the other treatments (Table 1). A PS-300 spectroradiometer [Apogee Instruments, Logan, Utah] was used to document the photosynthetic photon flux density (PPFD) of each R:FR treatment and of unfiltered sunlight (FIG. 4).

To block non-filtered wavelengths, Applicants constructed opaque boxes (55.9 cm L×30.5 cm W×10.1 cm H₁×20.3 cm H₂) from white corrugated plastic which enclosed the greenhouse trays containing dodder and host seedlings. The open tops of the boxes were then covered with one of the R:FR treatment films. A DC-powered fan (80 mm×80 mm×25 mm) [Sunon Inc., Brea, Calif.] was installed inside each box to exhaust excessive heat from 06:00-22:00 daily.

### Foraging Assay

To determine whether the ratio of R:FR influences the ability of C. campestris seedlings to locate nearby tomato hosts, the direction of dodder seedling growth was measured within a circular foraging arena relative to paired target tomatoes. Seven days after planting, tomato seedlings with expanded cotyledons were transplanted to greenhouse trays (3 seedlings per tray, evenly spaced in a single centered row) containing potting soil (without fertilizer) and moved to an insect-free greenhouse for 2-4 days before being transported outside for experiments. Approximately 80 C. campestris seedlings were exposed to each R:FR light treatment in two consecutive replicated experiments (actual sample sizes: control R:FR: n=79 C. campestris seedlings; low R:FR: n=83 seedlings; high R:FR: n=84 seedlings). On the first day of the experiment, newly germinated C. campestris seedlings (2-3 cm long) were planted 4.5 cm from the stem of tomato hosts, where each tomato was located in the middle between two dodder seedlings planted on opposite sides. In this way, a single tomato served as the target host for two individual dodder seedlings, which reduced both the total plant volatiles and variation in light cues present in the treatment boxes (described above). Trays were moved outside to a concrete patio and a treatment box was placed over the plants to filter sunlight. Plants received water daily. After seven days of foraging, the position and orientation of individual C. campestris seedlings relative to the nearby paired tomato hosts was recorded. This was accomplished by defining a circular perimeter around the base of each parasite seedling and recording the half (and quadrant) of the resulting circle in which the seedling resided with respect to the location of the tomato host (modified from the methods of Runyon et al. 2006). Data were analyzed in Minitab [version 14.1, Minitab Inc., State College, Pa.] using the chi-square test to compare the proportion of expected and observed seedlings growing into each arena half and quadrant.

### Parasitism Assay

To determine whether the ratio of R:FR influences the ability of Cuscuta seedlings to successfully attach to hosts, we measured rates of successful parasitism over time for C. campestris on tomato hosts and C. gronovii on jewelweed.

Cuscuta campestris: A total of 180 seedlings were exposed to each R:FR treatment in two consecutive replicated experiments. Tomato seedlings were prepared in the same way as in the foraging assays.

Cuscuta gronovii: Approximately 22 seedlings were exposed to each R:FR treatment in two consecutive replicated experiments (actual sample sizes: control R:FR: n=22 seedlings, low R:FR: n=21 seedlings, high R:FR: n=22 seedlings). Locally collected jewelweed host plants (described above) were grown outdoors until experimentation began.

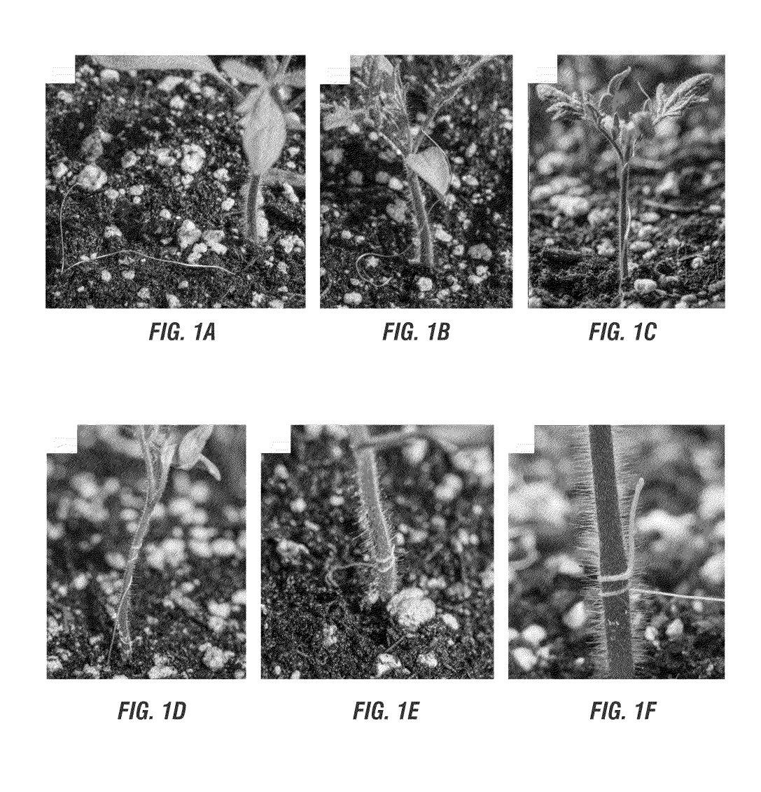

For both host-parasite systems, newly germinated Cuscuta seedlings were planted 1 cm from the stem of their respective host plants to ensure contact with the host. Trays were placed outside and a treatment box (described above) was positioned over the plants. After 7 days (C. campestris) or 10 days (C. gronovii), the progression of dodder parasitism was categorized as either No Host Contact, Unsuccessful Attachment (including seedlings that twined or coiled around the host, but without evidence of haustoria formation) or Successful Attachment (including seedlings that formed prehaustoria or mature haustoria). FIG. 1 illustrates examples of these three categories and the stages of parasitism progression within each. Data were analyzed in Minitab using binary logistic regression when test assumptions were met.

### Effects of Altered R:FR on Plant Growth and Biochemistry

To determine whether brief exposure to altered R:FR affects short-term plant growth, C. campestris seedlings and tomato hosts were grown (separately) beneath the treatment boxes described above for 7 days. At the conclusion of the experiment several short-term growth traits of the parasite and the host were measured. For the parasite, seedling length (control R:FR: n=29 seedlings; low R:FR and high R:FR: n=30 seedlings) was measured. For the host tomato, the number of expanded leaves (n=30 tomatoes for all treatments), height (n=30 for all treatments), dry mass (n=30 for all treatments) and constitutive levels of phytohormones (total jasmonic acid, JA; cis- and trans-isomers of JA; and total salicylic acid, SA; n=11 for all treatments) (see Supporting Information for detailed methods on the extraction and quantification of JA and SA) were measured. Host plant phytohormones (along with host volatile emissions, discussed below) are an aspect of the host phenotype that, if altered via variations in the ratio of R:FR, have the potential to influence host-parasite interactions as well as the overall quality of the host (e.g., defensive capability); thus it was important to quantify the effects of altered R:FR on these aspects of plant biochemistry.

As a preliminary attempt to determine whether brief exposure to altered R:FR affects the long-term growth of tomato hosts, Applicants grew tomato seedlings beneath the treatment boxes for 7 days then transplanted them to a common garden, where they received natural sunlight until they were harvested 54 days later. At the conclusion of the experiment several long-term growth traits of tomato were measured including the number of unopened buds, number of open flowers, number of senesced flowers, number of fruits, fruit fresh and dry mass, and total aboveground dry mass.

Short- and long-term effects of R:FR on plant growth were analyzed in Minitab using either the general linear model (GLM) with treatment as a fixed factor and Tukey's Test as a post-hoc analysis or nonparametric analyses (Kruskal-Wallis, Mann-Whitney U test) when GLM assumptions were not met.

To determine whether the ratio of R:FR affects the constitutive production of tomato host volatiles, Applicants collected volatiles from potted tomatoes (each pot contained four 18-day old plants) exposed to each of the three R:FR treatments (n=12 pots for each treatment). The ratio of R:FR was manipulated by affixing photoselective film to the outside of glass collection domes to prevent film-related odors from contaminating plant volatile samples. Collections occurred in three separate 48 h replicates (four pots per treatment in each replicate) and were conducted in a greenhouse in ambient sunlight in July 2013 (University Park, Pa.; approximately a 16 h photoperiod) using a push-pull collection system [Analytical Research Systems, Gainesville, Fla., USA]. Volatiles were tested for normality, log transformed if required, and analyzed in Minitab using a GLM with replicate as a random blocking factor.

### Active Light Manipulation

To actively manipulate light spectral quality and intensity, a custom LED light array called ELVIS (Effulgent LED Variable Intensity Spectrum) was used. It comprised emitters with different spectra (UV, green, red, deep red, far-red, infra-red, neutral white and warm white) [LED Engin Inc., San Jose, Calif.] driven with a constant current controller [TheLEDArt.com, Akimitsu Sadoi, New York City, N.Y.] (FIG. 5). The intensity of each channel was regulated using an open source microcontroller [Arduino, Italy] and pulse-width modulated breakout board [ADA Fruit, New York City, N.Y.]. The ratio of R:FR of each ELVIS treatment was similar to the ratio of R:FR of the photoselective films, while the light intensity (the amount of photosynthetically active radiation) was similar across all ELVIS R:FR treatments (Table 1 and FIG. 6).

### Parasitism Assay

A parasitism assay was conducted to determine whether the R:FR treatments emitted by ELVIS influences the ability of C. campestris seedlings to parasitize hosts. Seven days after seeds were planted, tomato seedlings with expanded cotyledons were transplanted to greenhouse trays containing potting soil (without fertilizer). Newly germinated C. campestris seedlings were planted 1 cm from the stem of tomato hosts. Plants were exposed to the R:FR treatments emitted by ELVIS during three separate trials (16 h photoperiod; n=15 seedlings for each treatment) for 7 days and then the progression of dodder parasitism was categorized (as described above) at the conclusion of each experiment (FIG. 1). Data were analyzed in the same way as the Passive Light Manipulation Parasitism Assay.

### Circumnutation Assay

To determine whether the ratio of R:FR affects the period of circumnutation of C. campestris seedlings, newly germinated seedlings (2-3 cm long) were planted in the center of a 6.7 cm diameter round plastic pot filled with general-purpose potting soil; host plants were not present. The pots were then placed in a shallow dish and watered from below for the duration of the experiment. Light treatments were illuminated by ELVIS during three separate trials (24 h photoperiod; n=8 seedlings for each treatment; FIG. 6). Light, temperature and relative humidity were monitored using a HOBO® model U12-012 data logger [Onset Computer Corporation, Bourne, Mass.].

To measure the period of circumnutation (i.e., the amount of time required to complete a full rotation), seedlings were photographed from above at 4 min intervals with a D200 Nikon camera [Nikon Corporation, Tokyo, Japan] for the duration of normal circumnutation movements until seedlings fell and made contact with the soil. Photographs were analyzed to determine the average period of circumnutation for each seedling. Applicants first calculated the amount of time required by individual seedlings to complete each 360° rotation using the photograph timestamps and then calculated the average period of circumnutation for individual seedlings as the average of all completed rotations. Data were analyzed in Minitab with a GLM (R:FR treatment was a fixed factor and temperature was a covariate in the model) and with Tukey's Test as a post-hoc analysis.

### Results

### Passive Light Manipulation

### Foraging Assay

After 7 days of foraging, a significant proportion of C. campestris seedlings grew toward the target tomato hosts under the control R:FR treatment (arena half: X²=30.39, P<0.000; arena quadrant: X²=84.19, P<0.000), and similar results were observed for the low R:FR treatment (arena half: X²=18.33, P<0.000; arena quadrant: X²=49.10, P<0.000) (Table 2). However, seedlings subjected to the high R:FR treatment did not exhibit clear evidence of directed growth toward tomato hosts (arena half: X²=0.762, P=0.383; arena quadrant: X²=3.333, P=0.343) (Table 2). These results indicate foraging dodder seedlings are less able to locate nearby hosts in environments containing a high ratio of R:FR.

### Parasitism Assay

Cuscuta campestris: After 7 days, almost all of the seedlings subjected to the control R:FR (98.9%) and low R:FR (94.5%) treatments had reached the Successful Attachment parasitism category, while few seedlings subjected to the high R:FR treatment had done so (15.0%) (Table 3). Indeed, 25.0% of seedlings exposed to high R:FR were not in contact with the host after 7 days and 60.0% remained in the Unsuccessful Attachment category (Table 3), which typically does not continue to progress beyond 7 days to result in subsequent parasitism (personal observation). Using binary logistic regression to compare the proportion of C. campestris seedlings at the Haustoria stage (falling under the Successful Attachment category) versus all other stages of parasitism revealed no statistical difference between the control R:FR and low R:FR treatments (Z=−1.03, P>0.305), while there was a clear difference between the control R:FR and high R:FR treatments (Z=−9.86, P<0.000).

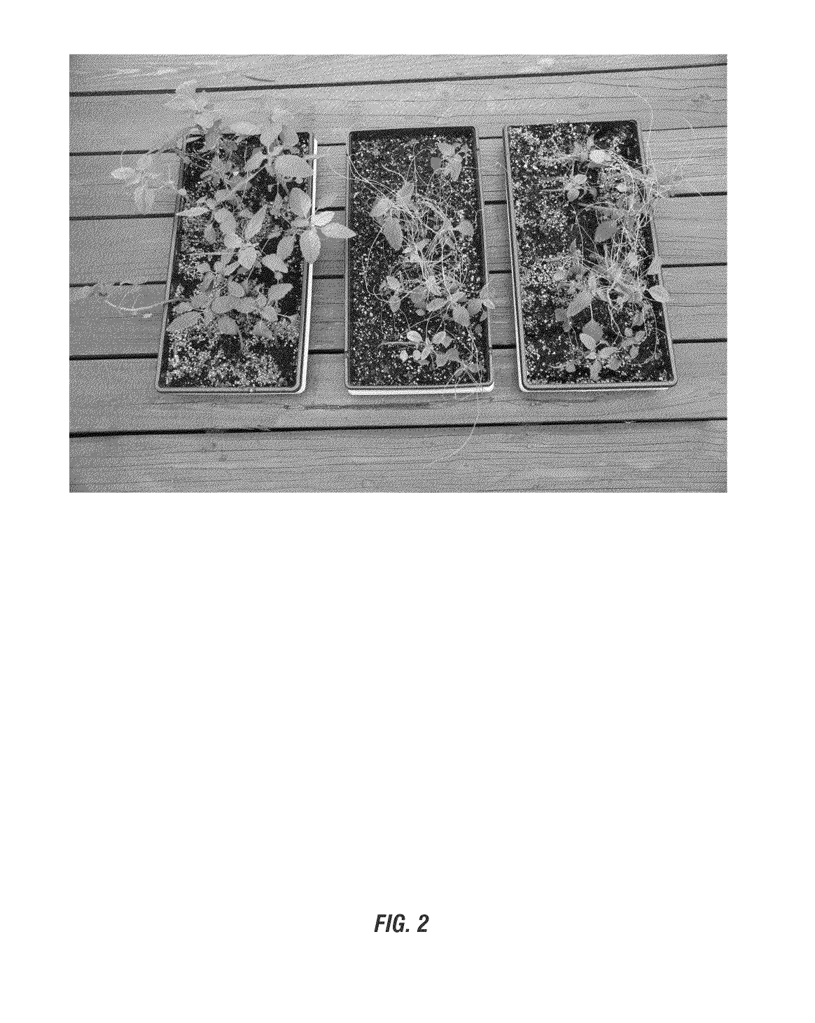

Cuscuta gronovii: After 10 days, 100% of the seedlings beneath the control R:FR and low R:FR treatments had reached the Successful Attachment parasitism category compared to 27.2% of seedlings beneath the high R:FR treatment (Table 3). The majority of seedlings beneath the high R:FR treatment (68.2%) were not in contact with their hosts (Table 3; these data were unable to be analyzed using binary logistic regression because test assumptions were not met). The initial parasitism success by C. gronovii seedlings beneath the control R:FR and low R:FR treatments resulted in extensive infestations by day 25 compared to the relatively mild infestation beneath the high R:FR treatment (FIG. 2).

Together, these results demonstrate dodder seedlings are less able to parasitize hosts in environments containing a high ratio of R:FR.

### Effects of Altered R:FR on Plant Growth and Biochemistry

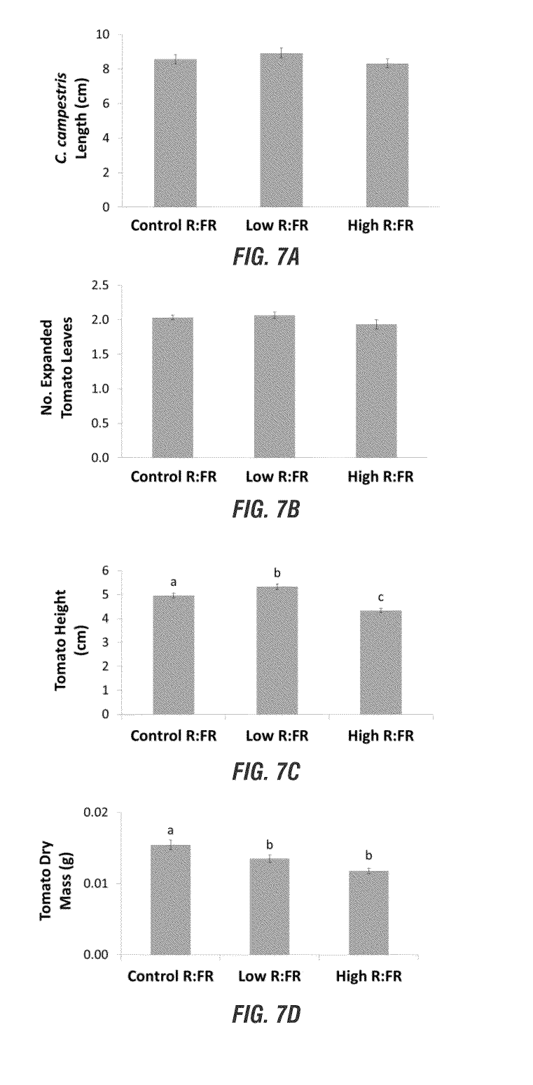

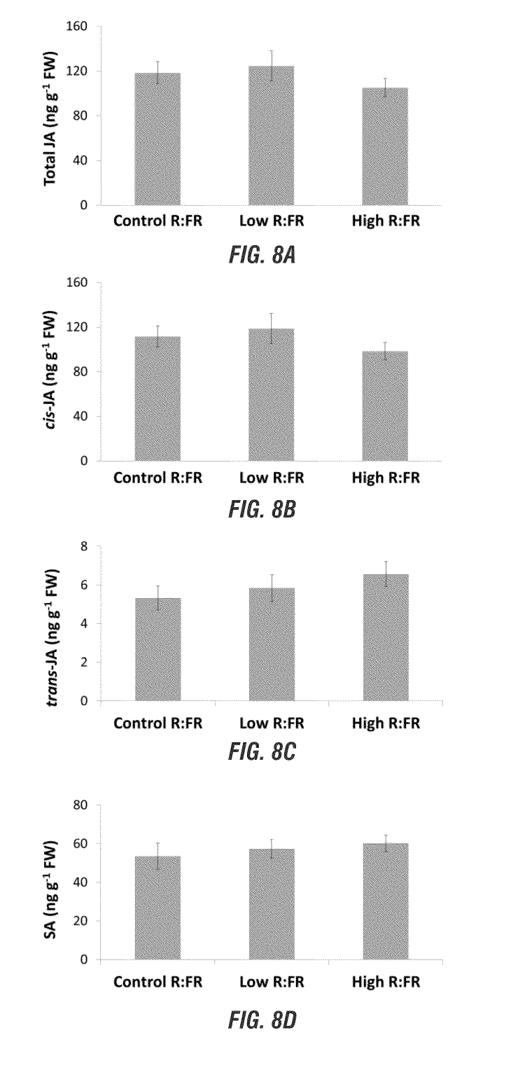

Exposure to the R:FR treatment did not affect C. campestris seedling length (GLM analysis, F=1.23, P=0.296; FIG. 7a). For tomato hosts, we also observed no difference in the number of fully expanded tomato leaves (Kruskal-Wallis analysis, H=3.80, df=3, P=0.284; FIG. 7b) or effects on constitutive levels of host phytohormones (total JA: GLM, F=0.88, P=0.427; cis-JA: GLM, F=0.96, P=0.394; trans-JA: GLM, F=1.74, P=0.195; SA: GLM, F=0.38, P=0.685; FIG. 8). However, R:FR treatment did significantly influence plant height (FIG. 7c), with tomatoes exposed to low R:FR being tallest and those exposed to high R:FR shortest (Mann-Whitney test, U_{control vs. low}=776.0, median_{control}=5, median_{low}=5, P<0.018; U_{low vs. high}=1245.0, median_{low}=5, median_{high}=4, P<0.000; U_{control vs. high}=1160.0, median_{control}=5, median_{high}=4, P<0.000). Tomato dry mass was also affected by R:FR treatment (FIG. 7d). Plants exposed to control R:FR were heavier than plants in either the low R:FR or high R:FR treatments (GLM analysis, F=11.69, P<0.000).

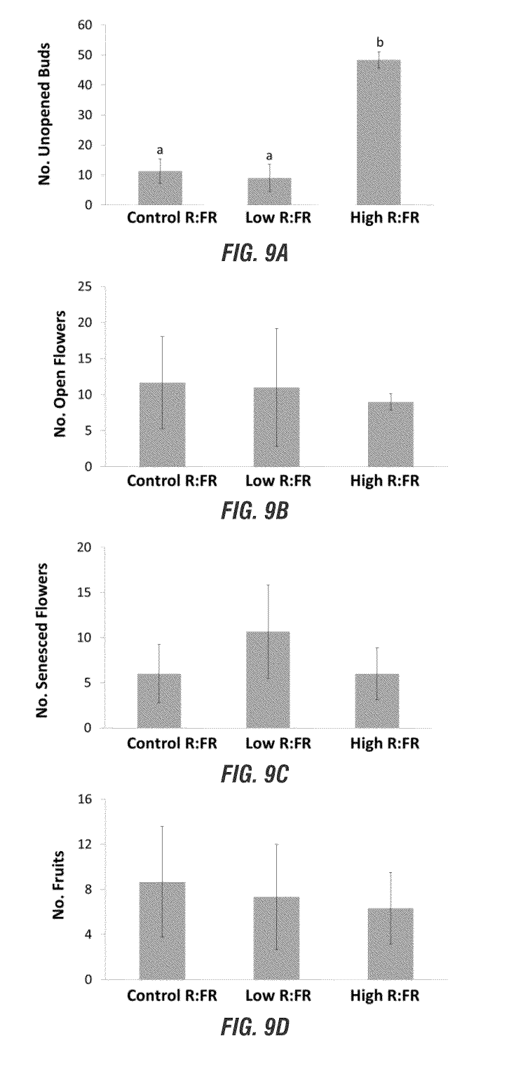

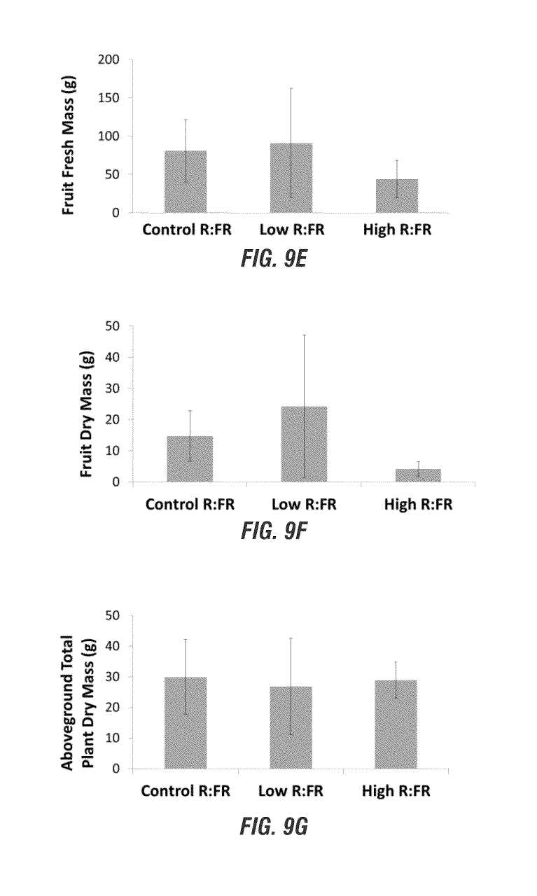

Tomatoes initially exposed to high R:FR for 7 days had significantly more unopened flower buds at the time of harvest (54 days later) compared to plants initially exposed to control R:FR or low R:FR conditions (GLM, F=32.3, P<0.001; FIG. 9a). However, the other traits that we measured did not differ significantly as a result of the initial short-term exposure to the R:FR treatments (number of open flowers: GLM, F=0.05, P=0.949; number of senesced flowers: GLM, F=0.48, P=0.641; number of fruits: GLM, F=0.07, P=0.930; fruit fresh mass: GLM, F=0.25, P=0.786; fruit dry mass: Kruskal-Wallis, H=0.37, df=2, P=0.832; and aboveground total plant dry mass: GLM, F=0.02, P=0.982; FIG. 9b-g).

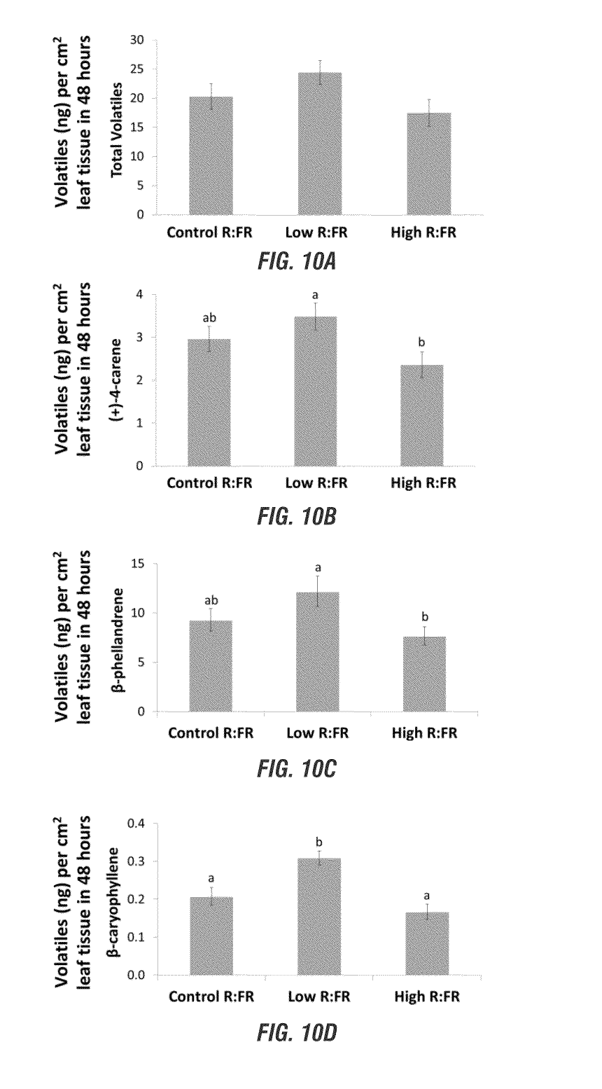

The ratio of R:FR had a marginal effect on the total emission of tomato volatiles, with a tendency for lower emissions under high R:FR compared to low R:FR (GLM: F=2.50, P=0.097; Tukey's test for post-hoc comparisons: control vs. low: P=0.392; control vs. high: P=0.646; low vs. high: P=0.082; FIG. 10a). Only three compounds, (+)-4-carene (GLM: F=3.43, P<0.044), β-phellandrene (GLM: F=3.48, P<0.043) and β-caryophyllene (GLM: F=9.54, P<0.001), showed significant differences in production with respect to R:FR treatments, each of which exhibited lower emissions under high R:FR compared to low R:FR (FIG. 10b-d). Compounds that were not affected by the ratio of R:FR included α-pinene, p-cymene, β-myrcene, (E)-β-ocimene, (Z)-β-ocimene, α-terpinolene, nonanal, octanoic acid, pentadecane, 2,4-bis(1,1-dimethhylethyl)-phenol and 16 unidentified compounds (data not shown).

### Active Light Manipulation

### Parasitism Assay

After 7 days, the majority of C. campestris seedlings subjected to the control R:FR (66.7%) and low R:FR (80.0%) ELVIS treatments had reached the Successful Attachment parasitism category, while none of the seedlings subjected to the high R:FR treatment were able to reach this stage (Table 3). The majority of seedlings beneath the high R:FR treatment (80.0%) remained in the Unsuccessful Attachment category (Table 3). (These data were not analyzed using binary logistic regression because test assumptions were not met.)

### Circumnutation Assay

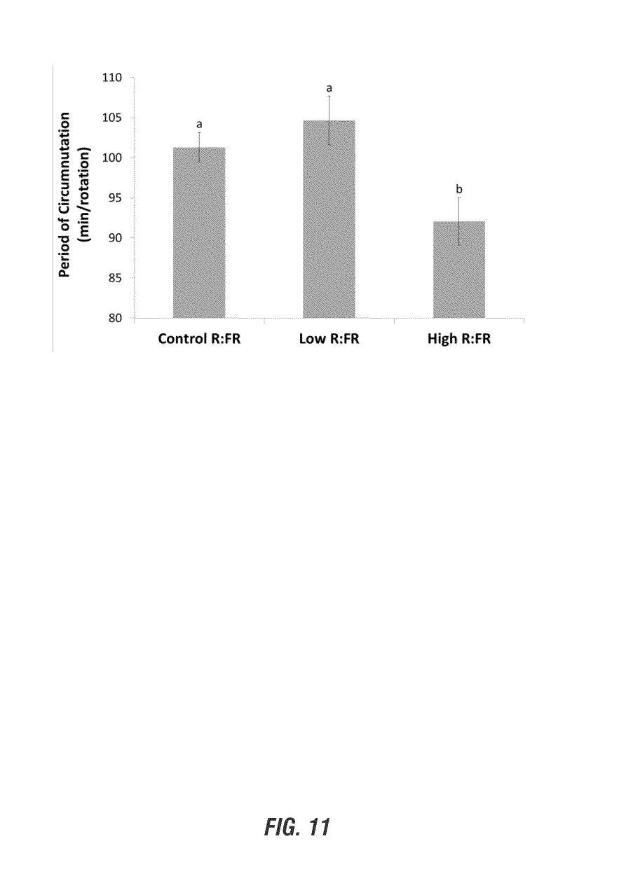

R:FR treatment significantly influenced the period of circumnutation of C. campestris seedlings (GLM_{R:FR Treatment}: F=7.09, P<0.005; FIG. 11). The average period of circumnutation was fastest in high R:FR environments (92.1 min±2.9) and significantly slower in control R:FR (101.3 min±1.8) and low R:FR environments (104.6 min±3.0). Ambient temperature, a covariate in the model, did not significantly contribute to this result (GLM_{Temperature}: F=2.42, P=0.136).

The results clearly demonstrate that manipulation of light spectral quality can significantly impact both the ability of parasitic dodder seedlings to locate nearby hosts and their ability to make successful attachments. Experimental treatments that created high R:FR light environments—either by passive filtering of sunlight or via active manipulation of light quality using LED emitters—resulted in dramatic reductions in host location and attachment success for seedlings of two different Cuscuta species utilizing different host plants. Furthermore, only limited evidence of long-term effects of spectral manipulation—during the period of susceptibility to dodder infestation—was observed on host plant growth. Thus, the results suggest that spectral manipulation (e.g., via the use of light filtering row covers) during early stages of crop plant growth might provide a viable method of preventing dodder infestations in agricultural crops.

Our results show high R:FR reduces host acquisition in two dodder species: C. gronovii, which is a major pest of cranberry and blueberry in the Northeast and northern Midwest USA as well as alfalfa, citrus, clover and grapevine (Dawson et al. 1994; Costea and Tardif 2006); and C. campestris, which is an extremely destructive international pest of dozens of crops (e.g., alfalfa, asparagus, beet, carrot, chickpea, clover, eggplant, faba bean, grape, honeydew melon, onion, potato and tomato as well as ornamental plants) (Costea and Tardif 2006). Thus, high R:FR would be expected to similarly disrupt host acquisition by other economically important dodder species such as C. epithymum, C. europaea, C. indecora, C. planiflora, C. pentagona and C. reflexa (Lanini and Kogan 2005).

In the experiments with dodder, spectral manipulation acted independently on two sequential stages of the host acquisition process—foraging and attachment—creating two lines of defense against the parasite, which is advantageous compared to the single defensive approach of traditional prevention and eradication methods. Applicants work also showed light spectral manipulation can control dodder using both passive and active methods. Passive manipulation, such as using photoselective polyethylene film to filter sunlight, could plausibly be incorporated into existing agricultural practices including row covers, high tunnels, soil sterilization materials and plastic mulches (“plasticulture”) in addition to using individual canopies to treat localized infestations. While active manipulation is currently more difficult to incorporate in field settings than passive manipulation, the rapid development of new lighting technologies such as LEDs and lasers will make this method more easily conducted.

Light spectral manipulation improves upon many of the limitations and trade-offs encountered with traditional forms of dodder control. It provides a non-invasive, chemical-free alternative to herbicide use that is especially ideal for organic production. It is also relatively inexpensive to employ compared to other costs incurred from controlling established infestations (e.g., purchasing genetically-engineered resistant crop varieties and corresponding selective herbicides, labor costs to remove established infestations by hand, profit losses from reduced crop quality and yield). Light spectral manipulation also has the potential to be deployed in ways that are more ecologically sustainable compared to traditional control methods. For example, photoselective film can be used in consecutive growing seasons to reduce waste and is made from materials that can be recycled after deterioration. Additionally, many of the new lighting technologies such as high power LEDs are extremely energy-efficient compared to other horticulture lighting options (e.g., high pressure sodium and metal halide lights).

### REFERENCES

Albert, M., Belastegui-Macadam, X., Bleischwitz, M. & Kaldenhoff, R. (2008) Cuscuta spp: parasitic plants in the spotlight of plant physiology, economy and ecology. Progress in Botany, 69, 267-277.
Ballaré, C. L. & Casal, J. J. (2000) Light signals perceived by crop and weed plants. Field Crops Research, 67, 149-160.
Benvenuti, S., Dinelli, G., Bonetti, A. & Catizone, P. (2005) Germination ecology, emergence and host detection in Cuscuta campestris. Weed Research, 45, 270-278.
Costea, M. (2007) Digital Atlas of Cuscuta (Convolvulaceae). Wilfrid Laurier University Herbarium, Ontario, Canada, http://www.wlu.ca/page.php?grp_id=2147&p=8968. Accessed: 14 Mar. 2014.
Costea, M. & Tardif, F. J. (2006) The biology of Canadian weeds. 133. Cuscuta campestris Yuncker, C. gronovii Willd. Ex Schult., C. umbrosa Beyr. Ex Hook., C. epithymum (L.) L. and C. epilinum Weihe. Canadian Journal of Plant Science, 86, 293-316.
Cudney, D. W., Orloff, S. B. & Reints, J. S. (1992) An integrated weed management procedure for the control of dodder (Cuscuta indecora) in alfalfa (Medicago sativa). Weed Technology, 6, 603-606.
Dawson, J. H., Musselman, L. J., Wolswinkel, P. & Dörr, I. (1994) Biology and control of Cuscuta. Review of Weed Science, 6, 265-317.
DePamphilis, C. W. & Palmer, J. D. (1990) Loss of photosynthetic and chlororespiratory genes from the plastid genome of a parasitic flowering plant. Nature, 348, 337-339.
DePamphilis, C. W., Young, N. D., & Wolfe, A. D. (1997) Evolution of plastid gene rps2 in a lineage of hemiparasitc and holoparasitic plants: Many losses of photosynthesis and complex patterns of rate variation. Proceedings of the National Academy of Sciences, 94, 7367-7372.
Furuhashi, K., Kanno, M. & Morita, T. (1995) Photocontrol of parasitism in a parasitic flowering plant, Cuscuta japonica Chois, cultured in vitro. Plant and Cell Physiology, 36, 533-536.
Gaertner, E. E. (1950) Studies of seed germination, seed identification and host relationships in dodders, Cuscuta spp. Cornell University Agricultural Experiment Station, Ithaca N. Y.
Goldwasser, Y., Lanini, W. T. & Wrobel, R. L. (2001) Tolerance of tomato varieties to lespedeza dodder. Weed Science, 49, 520-523.
Goldwasser, Y., Miryamchik, H., Sibony, M. & Rubin, B. (2012) Detection of resistant chickpea (Cicer arietinum) genotypes to Cuscuta campestris (field dodder). Weed Research, 52, 122-130.
Kelly, C. K. (1990) Plant foraging: a marginal value model and coiling response in Cuscuta subinclusa. Ecology, 71, 1916-1925.
Koch, A. M., Binder, C. & Sanders, I. R. (2004) Does the generalist parasitic plant Cuscuta campestris selectively forage in heterogeneous plant communities? New Phytologist, 162, 147-155.
Lanini, W. T. (2004) Economical methods for controlling dodder in tomatoes. Proceedings of the California Weed Science Society, 56, 57-59.
Lanini, W. T. & Kogan, M. (2005) Biology and management of Cuscuta in crops. Ciencia e Invetigación Agraría, 32, 165-179.
Lykas, C., Kittas, C. & Katsoulas, N. (2008) Gardenia jasminoides height control using a photoselective polyethylene film. HortScience, 43, 2027-2033.
Lyshede, O. B. (1985) Morphological and anatomical features of Cuscuta pedicellata and Cuscuta campestris. Nordic Journal of Botany, 5, 65-77.
Mishra, J. S., Moorthy, B. T. S., Bhan, M. & Yaduraju, N. T. (2007) Relative tolerance of rainy season crops to field dodder (Cuscuta campestris) and its management in niger (Guizotia abyssinica). Crop Protection, 26, 625-629.
Parker, C. (1991) Protection of crops against parasitic weeds. Crop Protection, 10, 6-22.
Parker, C. (2009) Observations on the current status of Orobanche and Striga problems worldwide. Pest Management Science, 65, 453-459.
Paul, N. D. & Moore, J. P. (2006) Manipulation of light spectrum for crop growth regulation. Acta Horticulturae, 711, 357-362.
Pennings, S. C. & Callaway, R. M. (2002) Parasitic plants: parallels and contrasts with herbivores. Oecologia, 131, 479-489.
Ramasubramanian, T. S., Paliyath, G., Rajagopal, I., Maheshwari, R. & Mahadevan, S. (1988) Hormones and Cuscuta development: in vitro induction of haustoria by cytokinin and its inhibition by other hormones. Journal of Plant Growth Regulation, 7, 133-144.
Rispail, N., Dita, M. A., González-Verdejo, C., Pérez-de-Luque, A., Castillejo, M. A., Prats, E., Román, B., Jorrin, J. & Rubiales, D. (2007) Plant resistance to parasitic plants: molecular approaches to an old foe. New Phytologist, 173, 703-712.
Runyon, J. B., Mescher, M. C. & De Moraes, C. M. (2006) Volatile chemical cues guide host location and host selection by parasitic plants. Science, 313, 1964-1967.
Sandler, H. A. (2010) Managing Cuscuta gronovii (swamp dodder) in cranberry requires an integrated approach. Sustainability, 2, 660-683.
Schmelz, E. A., Engelberth, J., Alborn, H. T., O'Donnell, P., Sammons, M., Toshima, H. & Tumlinson, J. H. (2003). Simultaneous analysis of phytohormones, phytotoxins, and volatile organic compounds in plants. Proceedings of the National Academy of Sciences USA, 100, 10552-10557.
Schmelz, E. A., Engelberth, J., Tumlinson, J. H., Block, A. & Alborn, H. T. (2004) The use of vapor phase extraction in metabolic profiling of phytohormones and other metabolites. The Plant Journal, 39, 790-808.
Tsivion, Y. (1978) Possible role of cytokinins in nonspecific recognition of a host in early growth of haustoria in the parasitic plant, Cuscuta campestris. Botanical Gazette, 139, 27-31.

TABLE 1
The ratio of red (650-670 nm) to far-red (710-740 nm) wavelengths
(R:FR), photosynthetic active radiation (summation of radiation
between 400-700 nm, PAR), percent transmission and average daily
temperature for each photoselective film and ELVIS R:FR treatment.

| | | | | | Avg. Daily |
|---|---|---|---|---|---|
| | Treat- | Ratio of | | Transmission | Temperature |
| Source | ment | R:FR | PAR | (%) | (° C.) |
| Photoselective | Sunlight | 0.691 | 1934.9 | 100 | — |
| Film | Control | 0.659 | 1377.4 | 71.18 | 21.5 |
| | Low | 0.391 | 1280.8 | 66.2 | 21.8 |
| | High | 1.697 | 1484.4 | 76.7 | 21.7 |
| ELVIS | Control | 0.690 | 156.2 | — | — |
| | Low | 0.395 | 155.6 | — | — |
| | High | 1.703 | 155.9 | — | — |

TABLE 2
The number of C. campestris seedlings favoring the arena half and quadrant
after foraging for 7 days beneath the photoselective film R: FR treatments.

| Photoselective | Seedlings choosing arena half | | | | Seedlings choosing arena quadrant | | | | | |
|---|---|---|---|---|---|---|---|---|---|---|
| Film R: FR | Toward | | | | Toward | | | | | |
| Treatment | Tomato | Away | X² | P | Tomato | Left | Right | Away | X² | P |
| Control | 64 | 15 | 30.39 | 0.000 | 55 | 7 | 10 | 7 | 84.19 | 0.000 |
| Low | 61 | 22 | 18.33 | 0.000 | 48 | 10 | 16 | 9 | 49.10 | 0.000 |
| High | 38 | 46 | 0.762 | 0.383 | 19 | 28 | 17 | 20 | 3.333 | 0.343 |

TABLE 3
Parasitism progression of Cuscuta seedlings after exposure
to the photoselective film and ELVIS R: FR treatments.

| | | Parasitism Progression (% in each category) | | | | | | |
|---|---|---|---|---|---|---|---|---|
| | | No Host | Unsuccessful Attachment | | | | | |
| | R: FR | Contact | | Loose | Close | Successful Attachment | | |
| Source | Treatment | No Contact | Contact | Twine | Coil | Prehaustoria | Haustoria | n |

C. campestris on tomato hosts

| | | | | | | | | |
|---|---|---|---|---|---|---|---|---|
| Photoselective | Control | 0.6 | 0 | 0.6 | 0 | 27.2 | 71.7 | 180 |
| Film | Low | 4.4 | 0.6 | 0 | 0.6 | 27.8 | 66.7 | 180 |
| | High | 25.0 | 16.7 | 35.0 | 8.3 | 11.1 | 3.9 | 180 |

C. gronovii on jewelweed hosts

| | | | | | | | | |
|---|---|---|---|---|---|---|---|---|
| Photoselective | Control | 0 | 0 | 0 | 0 | 0 | 100 | 22 |
| Film | Low | 0 | 0 | 0 | 0 | 0 | 100 | 21 |
| | High | 68.2 | 4.6 | 0 | 0 | 13.6 | 13.6 | 22 |

C. campestris on tomato hosts

| | | | | | | | | |
|---|---|---|---|---|---|---|---|---|
| ELVIS | Control | 26.7 | 0 | 6.7 | 0 | 20.0 | 46.7 | 15 |
| | Low | 20 | 0 | 0 | 0 | 53.3 | 26.7 | 15 |
| | High | 20 | 13.3 | 66.7 | 0 | 0 | 0 | 15 |

### Detailed Methods: Extraction and Quantification of JA and SA

Tomato seeds were planted in general-purpose potting soil (without fertilizer) and grown in the same insect-free growth chamber as previously described (FIG. 3). Seven days after planting, tomato seedlings with expanded cotyledons were transplanted to greenhouse trays containing potting soil and moved to an insect-free greenhouse for 2-4 days. Then the seedlings were placed outside to grow beneath the photoselective film treatment boxes for 7 days.

Approximately 100-200 mg of leaf tissue was removed from each plant, weighed and immediately frozen at −80° C. in liquid nitrogen in 2 mL tubes containing 1 g of 1.1 mm Zirmil beads [Saint-Gobain ZirPro, Le Pontet Cedex, France]. We used vapor-phase extraction to extract and quantify jasmonic acid (JA) and salicylic acid (SA) following the methods of Schmelz et al. 2003 and Schmelz et al. 2004. Plant tissue was ground by Zirmil beads in a Geno/Grinder® homogenizer and spiked with 10 μL of internal standard containing dihydro-JA. Phytohormones were then partitioned into an organic layer (dichloromethane) and derivatized from carboxylic acids to methyl esters. Using vapor-phase extraction, the products were volatilized and collected in filters containing 30 mg of HayeSep® Q [Alltech Associates, Inc., Deerfield, Ill.] at a rate of 1 L/min for 2 min. Phytohormones were eluted from the filters with 150 μL dichloromethane and then the samples were analyzed by coupled gas chromatography-mass spectrometry [Agilent Technologies, Inc., Santa Clara, Calif.] with isobutene chemical ionization using selected-ion monitoring (column: Agilent HP-1, 250 μm internal diameter, 0.1 μm film thickness). The column was held at 40° C. for 1 min and then increased at a rate of 15° C. per min until it reached a final temperature of 300° C. Phytohormones were quantified by measuring their production relative to the internal standard.

### Detailed Methods: Collection and Analysis of Plant Volatiles

Tomato seeds were planted in general-purpose potting soil with 5 g of fertilizer and grown in the same insect-free growth chamber as previously described (FIG. 3). Six seeds were initially sown in each pot (10 cm×10 cm×9 cm) and seven days later they were thinned to four seedlings per pot. Plants continued to grow in the chamber until they were used for volatile collections in the greenhouse on day 18. Volatiles were collected from potted tomatoes (each pot contained four 18-day old plants) exposed to each of the three R:FR treatments (n=12 pots for each treatment).

Pots were placed in individual basins and watered from below for the duration of the experiment. Tomato stems were wrapped with cotton and placed in the gap of a Teflon guillotine base. A 4-L glass dome was placed over the tomatoes and filtered air was immediately supplied at a rate of 2 L/min. Volatiles were collected using filters containing 30 mg of HayeSep® Q [Alltech Associates, Inc., Deerfield, Ill.] at a rate of 1 L/min for 48 continuous hours, which was the ideal collection interval based on pilot trials. Immediately after the collection concluded, tomatoes were destructively harvested to calculate leaf area using SigmaScan Pro 5 image analysis software [Systat Software Inc., San Jose, Calif.].

Filters were eluted with 150 μL dichloromethane and then 5 μL of internal standard containing n-octane (40 ng μL⁻¹) and nonyl-acetate (80 ng μL⁻¹) was added. Samples were injected into a Model 7890A gas chromatograph [Agilent Technologies, Inc., Santa Clara, Calif.] combined with a flame ionization detector (column: Agilent 19091J-413, HP-5, 0.32 mm internal diameter, 0.25 μm film thickness). The column was held at 35° C. for 0.5 min and then increased at a rate of 10° C. per min until it reached a final temperature of 240° C. Samples were also injected into a Model 6890 gas chromatograph combined with a mass spectrometer [Agilent Technologies, Inc.] using the same column and temperature ramp specifications. Volatiles (ng cm⁻² leaf tissue per 48 hours) were analyzed using MSD Chemstation [2003, Agilent Technologies, Inc.]. Compounds were quantified by measuring their production relative to the internal standard and they were identified through comparisons of retention times with known standards as well as comparisons with mass spectra from the NIST 2006 library.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims. Thus, many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims.

What is claimed is:

1. A method of reducing parasitism by Cuscuta and other dodder species in host plants comprising:
exposing said host plants to a light environment having a higher ratio of red to far-red light than natural sunlight, for a period of time effective for reducing said parasites from locating and acquiring hosts.

2. The method of claim 1 wherein said parasites include one or more species of Cuscuta C. epithymum, C. europaea, C. indecora, C. planiflora, C. campestris, C. gronovii, C. pentagona and/or C. reflexa.

3. The method of claim 1 wherein said ratio of red to far-red wavelengths is from about 0.7 to about 2.0.

4. The method of claim 1 wherein said exposing is by passive means.

5. The method of claim 4 wherein said passive means includes filtering natural sunlight.

6. The method of claim 4 wherein said passive means includes the use of photoselective film.

7. The method of claim 4 wherein said photoselective film is employed as a canopy.

8. The method of claim 1 wherein said exposing is by active means.

9. The method of claim 8 wherein said active means includes a lighting control apparatus within a crop cultivation housing.

10. The method of claim 1 wherein said exposure is employed for a time period before dodder seed germination through early dodder seedling development.

11. The method of claim 8 wherein said exposure is employed for a period of up to 6 weeks.

12. The method of claim 1 wherein said potential host plant comprises alfalfa, red clover, asparagus, carrot, chickpea, citrus, cucumber, cranberry, eggplant, faba bean, garlic, grapevine, melon, lespedeza, onion, pepper, potato, sugarbeet, sweet potato, tomato, coffee, coleus, dahlia, geranium, impatiens or mint.

13. The method of claim 1 wherein said potential host plant is tomato or jewelweed.

14. The method of claim 1 where said parasite is Cassytha species.

15. A method of reducing the ability of Cuscuta genus and other parasitic plants that are functionally and biologically similar to dodders (namely, Cassytha species) to locate and acquire a host plant comprising:
exposing said parasitic plants to a light environment having a higher ratio of red to far-red light than natural sunlight, specifically a ratio of red to far-red wavelengths of from about 0.7 to about 2.0 for a period of time effective for reducing parasite success in host location and host acquisition.

16. The method of claim 15 wherein said exposing is by passive means.

17. The method of claim 16 wherein said passive means includes filtering of natural sunlight.

18. The method of claim 15 wherein said passive means includes the use of photoselective film.

19. The method of claim 18 wherein said photoselective film is employed as a canopy.

20. The method of claim 15 wherein said exposing is by active means.

21. The method of claim 20 wherein said active means includes lighting control apparatus within a crop cultivation housing.

22. The method of claim 15 wherein said exposure is employed for a period of up to 6 weeks.

23. The method of claim 15 wherein said potential host plant comprises alfalfa, red clover, asparagus, carrot, chickpea, citrus, cucumber, cranberry, eggplant, faba bean, garlic, grapevine, melon, lespedeza, onion, pepper, potato, sugarbeet, sweet potato, tomato, coffee, coleus, dahlia, geranium, impatiens or mint.

24. The method of claim 15 wherein said parasite is a Cassytha species.

25. A lighting environment control facility for cultivation of crops, comprising:
a crop cultivation house which is formed of a light transmissive material and in which crops are cultivated; and
a lighting control means for adjusting light to be irradiated on the crops in the crop cultivation house, the crop cultivation house the lighting control means adjusts spectral radiance of a wavelength range of red light, and spectral radiance of a wavelength range of far-red light among the light to be irradiated on the crops in the crop cultivation house so that a ratio of red to far red light is higher than that ratio or red to far red light when the lighting control means is not installed.

26. The lighting environment control facility according to claim 25 wherein the lighting control means is a photoselective film that increases the ratio of red to far red light higher than when the control means is not installed.

27. The lighting environment control facility according to claim 25, wherein the lighting control means includes a light source that adjusts a lighting environment to be irradiated on the crops within the crop cultivation house.

28. The lighting environment control facility according to claim 27, wherein: the light source is installed to irradiate light from outside to inside the crop cultivation house, and includes a control means that controls operation of the light source; and the control means includes: a controller that controls the operation of the light source so that the ratio of red to far red light is higher than the ratio of red to far red light when the control means is not employed.

29. The method of claim 25 wherein said ratio of red to far-red wavelengths is from about from about 0.7 to about 2.0.

30. The facility of claim 25 further comprising a Effulgent LED Variable Intensity Spectrum.
